(19) United States
(12) Patent Application Publication
(10) Pub. No.: US 2014/0198215 A1
(43) Pub. Date: Jul. 17, 2014

(54) MULTIPLE CAMERA SYSTEMS WITH USER SELECTABLE FIELD OF VIEW AND METHODS FOR THEIR OPERATION

(71) Applicant: Sherry Schumm, Scottsdale, AZ (US)

(72) Inventor: Sherry Schumm, Scottsdale, AZ (US)

(21) Appl. No.: 13/743,330

(22) Filed: Jan. 16, 2013

(51) Int. Cl. H04N 7/18

(52) U.S. Cl. CPC H04N 7/181
USPC 348/159

(57) ABSTRACT

Embodiments of a system include a hub, a plurality of image capture devices, and one or more user terminals. The hub is adapted to receive images from the image capture devices, receive a request from a user terminal to provide images having desired characteristics, select images from the received images corresponding to the images having the desired characteristics, and send the selected images to the user terminal. The image capture devices are positioned in different locations with respect to an area, and each of the image capture devices is adapted to capture images of objects within the area, and to send the images to the hub. The user terminal includes a display device adapted to display images received from the hub, and a user interface for receiving a user input that indicates the desired characteristics.

### CROSS REFERENCE TO RELATED APPLICATION

This application claims the benefit of U.S. Provisional Application No. 61/587,125, filed Jan. 16, 2012.

### TECHNICAL FIELD

Embodiments relate to image capture devices, and more particularly to image capture devices for which the field of view may be remotely selected.

### BACKGROUND

Spectators enjoy watching a variety of sports and other events over mass media outlets. However, the provision of the imagery provided to the spectator is controlled exclusively by the production companies that film the events. Accordingly, a spectator may be dissatisfied when he or she is unable to view the event from a desired vantage point.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a simplified, block diagram of a multiple camera system capable of providing a user selectable field of view, in accordance with an embodiment;

FIG. 2 is a simplified diagram illustrating a plurality of image capture devices, in accordance with an embodiment;

FIG. 3 is a simplified block diagram of a hub, in accordance with an embodiment;

FIG. 4 is a simplified block diagram of a user terminal, in accordance with an embodiment; and

FIG. 5 is a flowchart of a method of operating the system of FIG. 1, in accordance with an embodiment.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or the following detailed description.

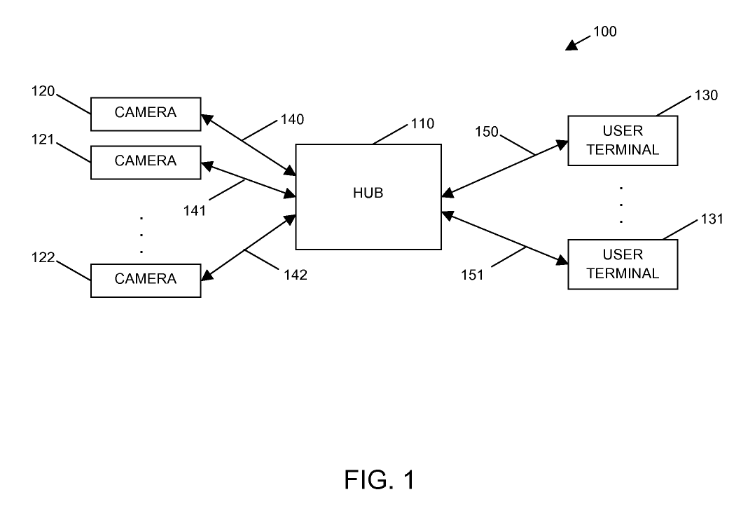

FIG. 1 is a simplified, block diagram of a multiple camera system 100 capable of providing a user selectable field of view, in accordance with an embodiment. System 100 includes a plurality of cameras 110, 111, 112 (also referred to herein as “image capture devices”), a hub 120, and one or more user terminals 130, 131. Although FIG. 1 illustrates three cameras 110-112 and two user terminals 130, 131, a system in accordance with an embodiment may include any number of cameras (e.g., from 2 to N, where N may be in the tens, hundreds, or thousands), and any number of user terminals (e.g., from 2 to M, where M may be in the tens, hundreds, thousands, or millions).

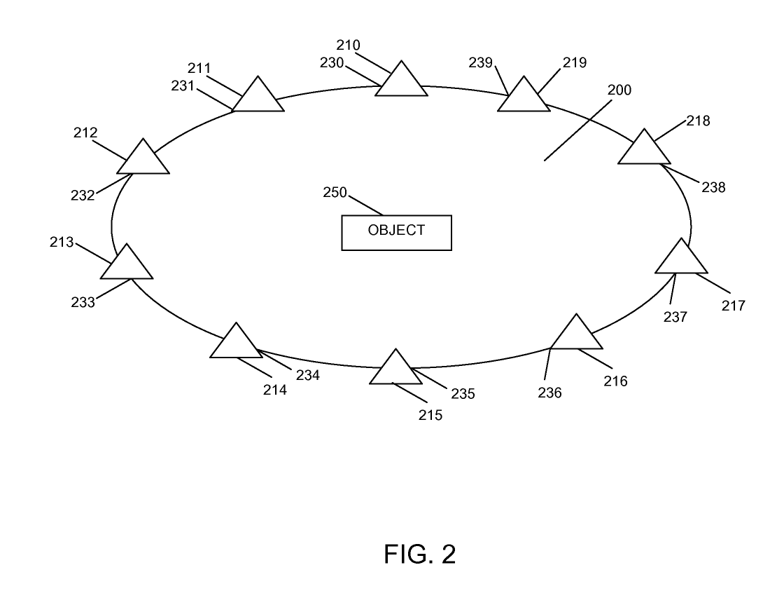

As will be described in more detail below, cameras 110-112 may be positioned in fixed locations (or vantage points) with respect to an area, and cameras 110-112 may capture images (e.g., in digital format) of objects within that area from the different locations. For example, FIG. 2 is a top view of an area 200, within which a plurality of cameras 210, 211, 212, 213, 214, 215, 216, 217, 218, 219 (e.g., cameras 110-112, FIG. 1) are positioned in fixed but different locations 230, 231, 232, 233, 234, 235, 236, 237, 238, 239 around the perimeter 202 of the area 200. According to an embodiment, from whichever location 230-239 each camera 210-219 is located, each camera 210-219 is capable of capturing images having a field of view within the area 200. For example, the area in which the cameras are located may be an enclosed area (e.g., a room, an arena, and so on), a route (e.g., a roadway, a shipping lane, and so on), or any interior or exterior space toward which multiple cameras may have their fields of view directed.

Although FIG. 2 shows ten cameras 210-219 arranged around the perimeter 202 of the area 200 in a co-planar manner, more or fewer cameras 210-219 may be employed. In addition, the cameras 210-219 may be positioned in co-planar (in one or multiple planes) or non-co-planar positions (e.g. to form a “net” of cameras around the area).

The cameras 210-219 may be spatially separated so that images produced by cameras 210-219 that are located in proximity to each other (e.g., cameras next to, adjacent to, or separated by a limited angular separation with respect to objects within the area) may be rendered (e.g., on a display device of a user terminal 130, 131) as three-dimensional images or video. Each camera 210-219 is capable of capturing images of objects (e.g., object 250, FIG. 2) within the area 200 from different image capture angles. For example, in FIG. 2, a first camera 210 in location 230 may produce images of a front of the object 250, a second camera 212 in location 232 may produce images of a right side of the object 250, a third camera 215 in location 235 may produce images of the back of the object 250, and a fourth camera 217 in location 237 may produce images of the left side of the object 250. In addition, cameras in proximity to each other (e.g., cameras 210, 211 in locations 230, 231, respectively) may produce images of the object 250 that may be combined to render a three-dimensional image of the object 250 (e.g., on a user terminal 130, 131).

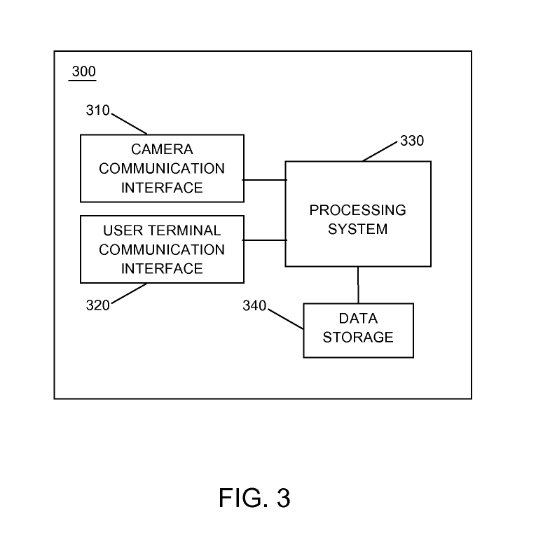

Referring again to FIG. 1, each camera 120-122 may capture images, which are provided by the camera 120-122 (e.g., in compressed or uncompressed format) to the hub 110 over one or more wired or wireless (e.g., RF) links 140, 141, 142 between the camera 120-122 and the hub 110. The hub 110 may be, for example, a centralized or distributed computing system. As illustrated in FIG. 3, for example, a hub 300 may includes one or more interfaces 310 for communicating with cameras 120-122 over links 140-142, one or more interfaces 320 for communicating with user terminals (e.g., communicating with user terminals 130, 131 over links 150, 151), a processing system 330, and a data storage system 340 (e.g., RAM, ROM, and so on, for storing images and software instructions, among other things). When hub 300 is implemented as a distributed system, for example, the processing system 330 may include multiple processing components that are co-located or that are communicatively coupled over wired or wireless networks.

Each camera 120-122 may capture images continuously or at the direction of the hub 110 (e.g., in response to control signals from the hub 110 received over links 140-142). In addition, each camera 120-122 may have the ability to alter the field of view of images captured by the camera 120-122. For example, each camera 120-122 may be capable of rotating about one or multiple axes (e.g., the camera may have pan-tilt capabilities) and/or each camera 120-122 may have zoom capabilities. The pan-tilt-zoom settings of each camera 120-122 may be controlled via control signals from the hub 110 (e.g., control signals received over links 140-142).

The hub 110 and the user terminal(s) 130, 131 may be communicatively coupled through communication links 150, 151 that include various types of wired and/or wireless networks (not illustrated), including the Internet, a local area network, a wide area network, a cellular network, and so on. Alternatively, the hub 110 may be incorporated into a user terminal 130, 131. The hub 110 provides images (e.g., in compressed or uncompressed format) captured by one or more cameras 120-122 to the user terminals 130, 131 via the network(s) using one or more communication protocols that are appropriate for the type of network(s).

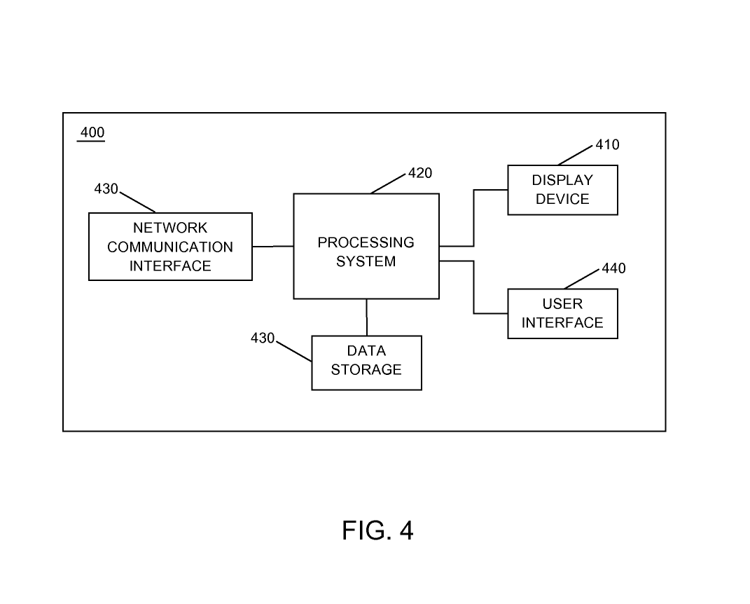

A user terminal 130, 131 may be a computer system, a television system, or the like, for example. As illustrated in FIG. 4, which is a simplified block diagram of a user terminal 400, a user terminal 400 may include a display device 410, a processing system 420, a network communication interface 430, a user interface 440, and data storage 450 (e.g., RAM, ROM, and so on, for storing images and software instructions, among other things). Via the network communication interface 430, the processing 420 system receives images from the hub (e.g., hub 110, FIG. 1), and causes the images to be displayed on the display device 410 (e.g., as still images or video, in two- or three-dimensions).

The user interface 440 may include a mouse, joystick, arrows, a remote control device, or other input means. In addition, when the display device 410 is a touchscreen type of display device, the display device 410 also may be considered to be an input means.

The various input means of the user interface 440 enable a user to specify a desired image capture angle, a desired image capture position, and/or a desired zoom setting. More specifically, via the user interface 440, a user may specify a desired image capture angle/position/zoom. As used herein, a “desired image capture angle” is an angle, with respect to an area (e.g., area 200, FIG. 2) or an object (e.g., object 250, FIG. 2), from which the user would like images to be captured for display on the display device 410. A “desired image capture position” is a position (e.g., one of positions 230-250, FIG. 2) from which the user would like images to be captured for display on the display device 410. A “desired zoom setting” indicates a level of magnification that the user would like images to be captured or provided for display on the display device 410.

For example, a depiction of an area (e.g., area 200) may be displayed on the display device 410, and the user may select (via user interface 440) a desired image capture position by selecting (e.g., using a mouse or a tap on a touchpad display) a location around the perimeter of the depicted area. Alternatively, the user may provide user inputs (via user interface 440) to cause the image capture angle to move, with respect to the image capture angle of currently displayed images. For example, using a mouse, joystick, keypad arrows, or a touchpad swipe, the user may provide user inputs to cause the image capture angle to move left, right, up, or down. Similarly, the user may provide user inputs to cause the zoom settings to change (e.g., to zoom in or out from an object).

Either way, and referring again to FIG. 1, the user inputs are translated by the processing system 420 into requests, which are sent via the network communication interface 430 to the hub 110 (e.g., a request is sent by user terminal 130 via link 150). In response to receiving the request(s), the hub 110 selects which images (or portions of images) produced by the cameras 120-122 will be provided over the link 150 (e.g., the communication network) to the user terminal 130. More specifically, the hub 110 selects images that correspond to the desired image capture angle and/or position. The hub 110 also may select a portion of an image that corresponds to a desired zoom setting (or the processing system 420 may select portions of images that correspond to a desired zoom setting after receiving the images from the hub 110). The hub 110 then transmits those images via the corresponding link 150 to the user terminal 130 for display by the user terminal 130 on the display device 410. In systems in which images are displayed in three dimensions, the hub 110 may transmit images from a camera at a first location (e.g., camera 210 at location 230) along with images from one or more cameras at locations proximate to the first location (e.g., camera 211 at location 231) to enable three-dimensional image display at the user terminal 130.

As indicated above, a user may discretely change the image capture position/angle for images displayed on the display device 410 by selecting an image capture position/angle that is different from the image capture position/angle corresponding to currently displayed images. In such a case, the displayed images (video) may appear to jump abruptly to the newly specified image capture position/angle, since the images are being produced by cameras 120-122 at different locations. Alternatively, a user may desire the displayed images to appear to dynamically rotate around an object (e.g., object 250, FIG. 2) within the area (e.g., area 200, FIG. 2). For example, when a user provides an indication to move left with respect to a currently displayed image, the hub 110 may sequentially provide images from adjacent cameras to emulate video that appears as a single camera moving to the left (e.g., the hub 110 sequentially provides images from cameras at positions 230, 231, 232, and so on). To simulate smooth movement, the hub 110 and/or the processing system 420 of the user terminal 400 may interpolate between images from different cameras. In addition, the system 100 may implement image display methods to compensate for overshoot.

According to an embodiment, the system 100 may cause images to be displayed in real time (excepting network delays) on a user terminal 130, 131. In addition, the system 100 may store captured images (e.g., at the hub 110 and/or at a user terminal 130, 131), thus enabling a user to view previously captured images.

In this manner, a user may dynamically select a vantage point (and magnification level) from which the user would like to view images (video) of an object (e.g., object 250) within an area (e.g., area 200). For example, in an embodiment, a system such as that described above may be deployed in a stadium, where the cameras are positioned around a perimeter of a playing area (e.g., a field or rink). The system may be used to capture images of a sporting event being held at the stadium, and a user (e.g., in a control booth or at a remote location, such as the user's home) may dynamically select the vantage points (and zoom level) from which the user would like to view the sporting event. In addition, the user may select previously captured images, for example, to replay a desired portion of video from any desired vantage point (or zoom level).

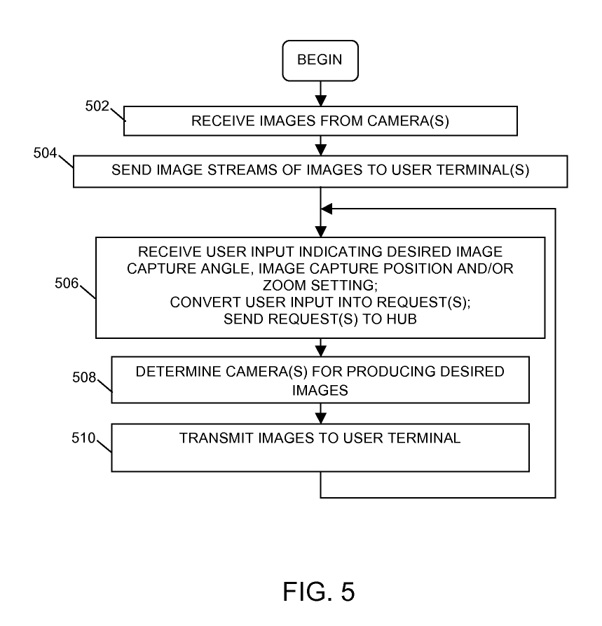

FIG. 5 illustrates a flowchart of a method depicting some of the processes performed by a system, such as the system of FIG. 1, in accordance with an embodiment. The method described in conjunction with FIG. 5 indicates processes that may be performed in conjunction with delivering and displaying images at a single user terminal. It is to be understood that multiple instances of the method may be simultaneously implemented by a system in order to deliver and display images at multiple user terminals.

The method may begin, in block 502, by the hub (e.g., hub 110) receiving images from one or more cameras (e.g., one or more of cameras 120-122, 210-219) over one or more links (e.g., links 140-142). In block 504, the hub may send streams of the images from one or more of the cameras to one or more user terminals (e.g., user terminals 130, 131) over links with the user terminals (e.g., links 150, 151). Images transmitted in such a manner may be considered to be default images (e.g., images that are selected at the hub without input from the user terminal).

In block 506, a user terminal (e.g., user terminal 130) may receive a user input, which indicates that the user would like the user terminal to receive and display images associated with a desired image capture angle, a desired image capture position, and/or a desired zoom setting. The user terminal may convert the user inputs into one or more requests, and may send the requests to the hub (e.g., via link 150).

In block 508, the hub receives the request(s), and determines which cameras may produce images associated with the desired image capture angle and/or desired image capture position, and/or the hub may determine a magnification setting (or zoom setting) associated with a desired zoom setting specified in a request. When the hub receives continuous streams of images from the cameras, the hub may then select images that correspond with the desired image capture angle and/or desired image capture position, and may send the images to the user terminal (e.g., via link 150). In instances in which a user indicates that the user would like to simulate panning around the perimeter of an area, the user terminal may transmit multiple requests indicating incremental changes to the desired image capture angle and/or desired image capture position. In instances in which a request indicates a desired zoom setting, the hub may either simulate zooming by selecting appropriate portions of an image, and/or the hub may communicate with the appropriate camera to cause the camera to adjust its magnification settings. Alternatively, the user terminal may simulate a zooming operation by selecting appropriate portions of an image. In instances in which a three-dimensional image display is implemented, the hub may select multiple streams of images to be sent to the user terminal, where the multiple streams correspond to images produced by multiple, adjacent cameras.

In block 510, the hub transmits the images corresponding to the desired image capture angle, desired image capture position, and/or desired zoom setting to the user terminal. The user terminal receives the images, and causes the images to be displayed on the display device. This process may then iterate each time the user provides a new user input indicating a new desired image capture angle, desired image capture position, and/or desired zoom setting. According to an embodiment, the user also may provide a user input that causes the hub to return to providing default images to the user terminal.

An embodiment of a system includes a hub adapted to receive images from a plurality of image capture devices, to receive a request from a user terminal to provide images having desired characteristics, to select images from the received images corresponding to the images having the desired characteristics, and to send the selected images to the user terminal. According to a further embodiment, the system also includes the plurality of image capture devices, where the plurality of image capture devices are positioned in different locations with respect to an area, and each of the plurality of image capture devices is adapted to capture images of objects within the area, and to send the images to the hub. According to another further embodiment, the system also includes the user terminal, which in turn includes a display device adapted to display images received from the hub, and a user interface for receiving a user input that indicates the desired characteristics.

An embodiment of a method includes a hub receiving images from a plurality of image capture devices, receiving a request from a user terminal to provide images having desired characteristics, selecting images from the received images corresponding to the images having the desired characteristics, and sending the selected images to the user terminal. According to a further embodiment, the method includes the plurality of image capture devices capturing images of objects within an area around which the image capture devices are positioned, and sending the images of the objects to the hub. According to another further embodiment, the method includes the user terminal displaying the images received from the hub, receiving a user input that indicates the desired characteristics, and sending the request to provide the images having the desired characteristics. According to a further embodiment, receiving the user input includes receiving a user input that indicates a characteristic selected from a desired image capture angle, a desired image capture position, and a desired zoom setting.

The connecting lines shown in the various figures contained herein are intended to represent exemplary functional relationships and/or physical couplings between the various elements. It should be noted that many alternative or additional functional relationships or physical connections may be present in an embodiment of the subject matter. In addition, certain terminology may also be used herein for the purpose of reference only, and thus are not intended to be limiting, and the terms “first”, “second” and other such numerical terms referring to structures do not imply a sequence or order unless clearly indicated by the context.

The foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with) another element, and not necessarily mechanically. Thus, although the schematic shown in the figures depict one exemplary arrangement of elements, additional intervening elements, devices, features, or components may be present in an embodiment of the depicted subject matter.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A system comprising:
a hub adapted to receive images from a plurality of image capture devices, to receive a request from a user terminal to provide images having desired characteristics, to select images from the received images corresponding to the images having the desired characteristics, and to send the selected images to the user terminal.

2. The system of claim 1, further comprising:
the plurality of image capture devices, wherein the plurality of image capture devices are positioned in different locations with respect to an area, and each of the plurality of image capture devices is adapted to capture images of objects within the area, and to send the images to the hub.

3. The system of claim 1, further comprising:
the user terminal, wherein the user terminal includes a display device adapted to display images received from the hub; and
a user interface for receiving a user input that indicates the desired characteristics.

4. A method comprising:
receiving, by a hub, images from a plurality of image capture devices;
receiving, by the hub, a request from a user terminal to provide images having desired characteristics;
selecting, by the hub, images from the received images corresponding to the images having the desired characteristics; and
sending, by the hub, the selected images to the user terminal.

5. The method of claim 4, further comprising:
capturing, by the plurality of image capture devices, images of objects within an area around which the image capture devices are positioned; and
sending, by the image capture devices, the images of the objects to the hub.

6. The method of claim 4, further comprising:
displaying, by a display device of the user terminal, the images received from the hub;
receiving, by a user interface of the user terminal, a user input that indicates the desired characteristics; and
sending, by the user terminal, the request to provide the images having the desired characteristics.

7. The method of claim 6, wherein receiving the user input comprises receiving a user input that indicates a characteristic selected from a desired image capture angle, a desired image capture position, and a desired zoom setting.
